(19) United States
(12) Patent Application Publication
(10) Pub. No.: US 2025/0202550 A1
(43) Pub. Date: Jun. 19, 2025

(54) METHOD FOR REPORTING AN ANTENNA SWITCHING CAPABILITY AND APPARATUS

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 18/844,300

(22) PCT Filed: Mar. 7, 2022
(86) PCT No.: PCT/CN2022/079607

§ 371 Date: Sep. 5, 2024

(51) Int. Cl. H04B 7/06; H01Q 1/24; H04B 7/08

(52) U.S. Cl. CPC H04B 7/0608; H04B 7/0802; H01Q 1/246

(57) ABSTRACT

A method for reporting an antenna switching capability, including: determining one or more antenna combinations of a terminal in a case that a number of downlink data layers is less than or equal to a number of transmitting antennas; reporting antenna switching capabilities of the antenna combinations to a network device.

### CROSS-REFERENCE TO RELATED APPLICATIONS

The present application is a U.S. National Stage of International Application No. PCT/CN2022/079607, filed on Mar. 7, 2022, the contents of all of which are incorporated herein by reference in their entireties for all purposes.

### BACKGROUND

In order to adapt to a current service or scenario, a terminal needs to switch antenna configurations and report an antenna switching capability to a network device, so that the network device can configure a corresponding sounding reference signal (SRS) resource according to the capability reported by the terminal.

### SUMMARY

The disclosure relates to the technical field of communication, and in particular to a method for reporting an antenna switching capability, and an apparatus.

In a first aspect, the examples of the disclosure provide a method for reporting an antenna switching capability. The method is performed by a terminal and includes: determining one or more antenna combinations of the terminal in a case that a number of downlink data layers is less than or equal to a number of transmitting antennas; and reporting antenna switching capabilities of the antenna combinations to a network device.

In a second aspect, the examples of the disclosure provide a method for reporting an antenna switching capability. The method is performed by a network device and includes: receiving an antenna switching capability of an antenna combination reported by a terminal, where the terminal includes one or more antenna combinations.

In a third aspect, the examples of the disclosure provide a communication apparatus. The communication apparatus has some or all of functions of the terminal in the method example of the first aspect. For example, the communication apparatus may have some or all of the functions in the examples of the disclosure, or may have the functions of implementing any one of the examples of the disclosure alone. The functions may be implemented through hardware, or by executing corresponding software by hardware. The hardware or software includes one or more units or modules corresponding to the functions.

In a fourth aspect, the examples of the disclosure provide another communication apparatus. The communication apparatus has some or all of functions of the network device in the method example of the second aspect. For example, the communication apparatus may have some or all of the functions in the examples of the disclosure, or may have the functions of implementing any one of the examples of the disclosure alone. The functions may be implemented through hardware, or by executing corresponding software by hardware. The hardware or software includes one or more units or modules corresponding to the functions.

In a fifth aspect, the examples of the disclosure provide a communication apparatus. The communication apparatus includes one or more processors. The one or more processors are collectively configured to execute the method of the first aspect when executing a computer program stored in a memory.

In a sixth aspect, the examples of the disclosure provide a communication apparatus. The communication apparatus includes one or more processors. The one or more processors are collectively configured to execute the method of the second aspect when executing a computer program stored in a memory.

In a seventh aspect, the examples of the disclosure provide a communication apparatus. The communication apparatus includes one or more processors and a memory. The memory stores a computer program. The one or more processors are collectively configured to execute the computer program stored in the memory to cause the communication apparatus to execute the method of the first aspect.

In an eighth aspect, the examples of the disclosure provide a communication apparatus. The communication apparatus includes one or more processors and a memory. The memory stores a computer program. The one or more processors are collectively configured to execute the computer program stored in the memory to cause the communication apparatus to execute the method of the second aspect.

In a ninth aspect, the examples of the disclosure provide a communication apparatus. The apparatus includes one or more processors and an interface circuit. The interface circuit is configured to receive a code instruction and transmit the code instruction to the one or more processors. The one or more processors is configured to carry out the code instruction to cause the communication apparatus to execute the method of the first aspect.

In a tenth aspect, the examples of the disclosure provide a communication apparatus. The apparatus includes one or more processors and an interface circuit. The interface circuit is configured to receive a code instruction and transmit the code instruction to the one or more processors. The one or more processors is configured to carry out the code instruction to cause the communication apparatus to execute the method of the second aspect.

In an eleventh aspect, the examples of the disclosure provide a non-transitory computer-readable storage medium. The non-transitory computer-readable storage medium is configured to store an instruction for a terminal. When the instruction is executed, the terminal is caused to execute the method of the first aspect.

In a twelfth aspect, the examples of the disclosure provide a non-transitory computer-readable storage medium. The non-transitory computer-readable storage medium is configured to store an instruction for a network device. When the instruction is executed, the network device is caused to execute the method of the second aspect.

### BRIEF DESCRIPTION OF DRAWINGS

In order to more clearly illustrate the examples of the disclosure or the technical solution in the background, the accompanying drawings required for the examples of the disclosure or the background will be explained below.

FIG. 1 is a schematic diagram of an architecture of a communication system according to an example of the disclosure.

FIG. 2 is a flowchart of a method for reporting an antenna switching capability according to an example of the disclosure.

FIG. 3 is a flowchart of a method for reporting an antenna switching capability according to an example of the disclosure.

FIG. 4 is a flowchart of a method for reporting an antenna switching capability according to an example of the disclosure.

FIG. 5 is a flowchart of a method for reporting an antenna switching capability according to an example of the disclosure.

FIG. 6 is a flowchart of a method for reporting an antenna switching capability according to an example of the disclosure.

FIG. 7 is a flowchart of a method for reporting an antenna switching capability according to an example of the disclosure.

FIG. 8 is a flowchart of a method for reporting an antenna switching capability according to an example of the disclosure.

FIG. 9 is a schematic structural diagram of a communication apparatus according to an example of the disclosure.

FIG. 10 is a schematic structural diagram of a communication apparatus according to an example of the disclosure.

FIG. 11 is a schematic structural diagram of a chip according to an example of the disclosure.

### DETAILED DESCRIPTION

Description will be made in detail to examples here, instances of which are illustrated in the accompanying drawings. When the following description relates to the accompanying drawings, the same numbers in different accompanying drawings refer to the same or similar elements unless otherwise indicated. The embodiments described in the following examples do not represent all embodiments consistent with the disclosure. Rather, they are merely instances of apparatuses and methods consistent with some aspects of the disclosure as detailed in the appended claims.

The terms used in the examples of the disclosure are used to describe specific examples, rather than limit the examples of the disclosure. The singular forms such as “a”, “an”, and “the” used in the examples of the disclosure and the appended claims are also intended to include the plural forms, unless clearly stated in the context otherwise. It should be understood that the term “and/or” as used here refers to and encompasses any or all possible combinations of one or more of associated listed items.

It should be understood that although the terms of first, second, third, etc. may be employed in the examples of the disclosure to describe various information, such information should not be limited to these terms. These terms are used to distinguish the same type of information from each other. For example, first information may also be referred to as second information, and similarly, second information may also be referred to as first information, without departing from the scope of the examples of the disclosure. Depending on the context, the word “if” as used here can be interpreted as “in the case of”, “when”, or “in response to determining”.

For concision and easy understanding, the terms “greater than” or “smaller than”, and “higher than” or “lower than” are used here to denote a magnitude relation. However, those skilled in the art can understand that the term “greater than” also covers the meaning of “greater than or equal to”, and the term “smaller than” also covers the meaning of “smaller than or equal to”; and the term “higher than” covers the meaning of “higher than or equal to”, and the term “lower than” also covers the meaning of “lower than or equal to”.

Examples of the disclosure provide a method for reporting an antenna switching capability, and an apparatus, so as to solve the problem of how to report an antenna switching capability when an uplink of a terminal is enhanced to support transmission of more than four layers, and define a new reporting mode for the terminal to support transmission of more than four layers. Indication information of an antenna switching capability is reported to a network device, such that the network device can configure appropriate sounding reference signal (SRS) resources for the terminal according to the antenna switching capability of an antenna combination reported by the terminal.

For ease of understanding, terms involved in the disclosure are introduced at first.

### 1. Sounding Reference Signal (SRS)

In a 5th generation (5G) new radio (NR) system, an uplink SRS may be a periodic, semi-persistent or aperiodic SRS with a narrowband or wideband and one or more ports. Uplink SRS parameters are configured by a network to a terminal. Parameters including a port number, a frequency-domain resource location, a time-domain resource location, a sequence, a sequence cyclic offset, etc. may be configured.

The network may configure a plurality of uplink sounding resource SRS sets for the terminal. One resource set includes one or more SRS resources.

### 2. Antenna Switching

The NR system supports a next generation NodeB (gNB) side to obtain downlink channel information by channel reciprocity, so as to improve downlink data transmission performance. In order to support the gNB to effectively obtain downlink information by channel reciprocity under various terminal transceiving capabilities, the SRS reference signal is specially designed for the NR system, and SRS resource configurations are different for different antenna configurations.

For example, for a terminal with transmitting antennas (“Tx”) and receiving antennas (“Rx”) identical in number (T=R), the gNB may be configured with two SRS resource sets at most. One SRS resource exists in one set, and a number of ports is equal to a number of the transmitting antennas (“T”) of the terminal. One of the two SRS resource sets may be configured as periodic, and the other one may be configured as aperiodic. For a terminal with one transmitting antennas and two receiving antennas (1T2R), the gNB may be configured with two SRS resource sets at most. Two SRS resources exist in one set, and each SRS resource has one port. The term “Tx” represents transmitting antennas and the term “T” represents the number of transmitting antennas. The term “Rx” represents receiving antennas and the term “R” represents the number of receiving antennas.

In order to better understand a method for reporting an antenna switching capacity disclosed in the examples of the disclosure, a communication system to which the examples of the disclosure are applicable is described.

The communication system provided in the examples of the disclosure may include, but is not limited to, a transmitting device and a receiving device. In some examples, the transmitting device may be a terminal, and the receiving device may be a network device.

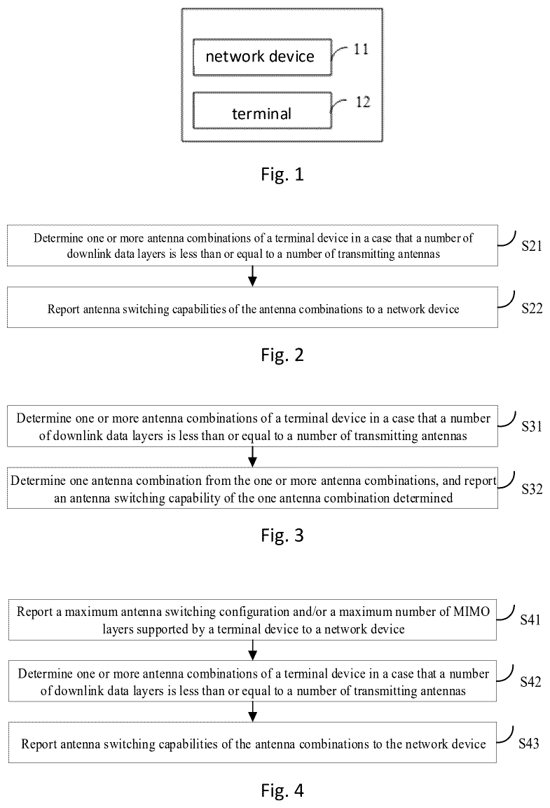

With reference to FIG. 1, FIG. 1 is a schematic diagram of an architecture of a communication system according to an example of the disclosure. The communication system may include, but is not limited to, one network device and one terminal. The number and form of devices shown in FIG. 1 are illustrative and do not constitute a limitation to the example of the disclosure. The communication system may include two or more network devices and two or more terminals in an actual application. For example, the communication system shown in FIG. 1 includes one network device 11 and one terminal 12.

It should be noted that the technical solution of the example of the disclosure can be applied to various communication systems, for example, a long term evolution (LTE) system, a 5th generation (5G) mobile communication system, a 5G new radio system, or other future new mobile communication systems, etc.

The network device 11 in the example of the disclosure is an entity on a network side for transmitting or receiving signals. For example, the network device 11 may be an evolved NodeB (eNB), a transmission reception point (TRP), a next generation NodeB (gNBs) in an NR system, a base station in other future mobile communication systems, or an access nodes in a wireless fidelity (WiFi) system, etc. The example of the disclosure does not limit a particular technology and a particular device form used by the network devices. The network device provided in the example of the disclosure may be composed of a central unit (CU) and a distributed unit (DU). The CU may also be referred to as a control unit. By using a CU-DU structure, protocol layers of the network device, such as a base station, may be split, functions of some protocol layers are centrally controlled by the CU, and functions of some or all of the remaining protocol layers are distributed in the DU, and the DU is centrally controlled by the CU.

The terminal 12 in the example of the disclosure is an entity on a user side configured to receive or transmit signals, such as a mobile phone. The terminal 12 may also be referred to as a terminal, user equipment (UE), a mobile station (MS), a mobile device (MT), etc. The terminal may be a car with a communication function, a smart car, a mobile phone, an Internet-of-Things device such as NB-IoT or (e) MTC, a wearable device, a Pad, a computer with a radio transceiver function, a virtual reality (VR) terminal, an augmented reality (AR) terminal, a radio terminal in industrial control, a radio terminal in self-driving, a radio terminal in remote medical surgery, a radio terminal in a smart grid, a radio terminal in transportation safety, a radio terminal in a smart city, a radio terminal in smart home, etc. The example of the disclosure does not limit a particular technology and a particular device configuration used by the terminal.

It can be understood that the communication system described in the example of the disclosure is for the purpose of more clearly illustrating the technical solutions provided in the examples of the disclosure, and does not constitute a limitation on the technical solutions provided in the examples of the disclosure. Those skilled in the art will know that the technical solutions provided in the examples of the disclosure are also applicable to similar technical problems along with evolution of a system architecture and emergence of new service scenes.

The method for reporting an antenna switching capacity and an apparatus provided in the disclosure are described in detail in conjunction with the accompanying drawings.

As shown in FIG. 2, FIG. 2 is a flowchart of a method for reporting an antenna switching capability according to an example of the disclosure. As shown in FIG. 2, the method is performed by a terminal and may include, but is not limited to steps S21 and S22.

S21, one or more antenna combinations of the terminal are determined in a case that a number of downlink data layers is less than or equal to a number of transmitting antennas.

It should be noted that the number of downlink data layers of the terminal is less than or equal to the number of transmitting antennas of the terminal. The number of downlink data layers of the terminal may include a number of multiple input multiple output (MIMO) layers, that is, a maximum number of MIMO layers is limited. For example, when the terminal is configured with eight transmitting antennas (Transport, Tx), and four downlink data layers are provided, the terminal is in a situation of a limited number of data layers. For another example, when the terminal is configured with 8Tx, and the maximum number of downlink data layers is eight, the terminal is still in a situation of a limited number of data layers.

In the example of the disclosure, it may be determined that the terminal determines one or more antenna combinations based on the number of downlink data layers and the number of transmitting antennas (“T”) or the number of receiving antennas (“R”) in a case that the number of data layers is limited. For example, when the terminal supports 8Tx, and the number of downlink data layers is limited to four, the downlink data layers supported by the terminal may be one layer, two layers, three layers, and four layers, and all the transmitting antennas and the receiving antennas (“Rx”) may be divided into two antenna transceiving combinations of 4T×4Rx. For another example, when the terminal supports 4Tx, and the number of downlink data layers is limited to two, the downlink data layers supported by the terminal may be one layer and two layers, and the transmitting antennas and the receiving antennas may be divided into two antenna transceiving combinations of 2T×2Rx, and may also be divided into two antenna groups of 1T×2Rx. For yet another example, when the terminal supports 8Tx, and the number of downlink data layers is limited to two, the downlink data layers supported by the terminal may be one layer and two layers, and the transmitting antennas and the receiving antennas may be divided into four antenna transceiving combinations of 2T×2Rx, and may also be divided into four antenna combinations of 1T×2Rx.

S22, antenna switching capabilities of the antenna combinations are reported to the network device.

The examples of the disclosure provide the method for reporting an antenna switching capability, so as to solve the problem of how to report an antenna switching capability when an uplink of the terminal is enhanced to support transmission of more than four layers, and define a new reporting mode for the terminal to support transmission of more than four layers. Indication information of the antenna switching capability is reported to the network device, such that the network device can configure appropriate SRS resources for the terminal according to the antenna switching capability of an antenna combination reported by the terminal.

Different antenna combinations correspond to different antenna switching capability combinations. Accordingly, SRS resources configured by the network device for the terminals with different antenna switching capabilities are also different, such the network device needs to configure SRS resources matching the antenna switching capabilities within a capability range based on the capabilities reported by the terminal. In the example, the antenna switching capabilities of the antenna combinations may be transmitted from the terminal to the network device, such that the network device may be informed about a plurality of transceiving capabilities that the terminal can support, and one or more corresponding SRS resources may be further configured for the terminal according to the plurality of transceiving capabilities that the terminal can support. The SRS resource may be configured to obtain channel state information (CSI), and further to obtain uplink channel quality.

Continuing to take the situation that the terminal supports 8Tx and the number of downlink data layers is limited to four as an example, 8Tx of the terminal may be divided into two antenna combinations of 4T×4Rx. Antenna switching capabilities corresponding to the two antenna combinations of 4T×4Rx may both be 4T4R, or may both be 2T4R, or may be 1T4R and 2T4R respectively.

In some examples, grouping may be performed based on Tx or Rx to obtain an antenna combination of nTmR of the terminal, where n and m are positive integers greater than or equal to 1 and less than or equal to the number of transmitting antennas. In some examples, the terminal is a terminal including a plurality of antenna panels. Different panels may correspond to different antenna combinations.

In some examples, antenna switching capabilities of all the antenna combinations may be reported by the terminal simultaneously. In some other examples, antenna switching capabilities of all the antenna combinations may be reported by the terminal separately. In still other examples, switching capabilities of part antenna combinations of all antenna combinations may be reported by the terminal. For example, in a case that the terminal has two antenna combinations, an antenna switching capability of one of the antenna combinations may be reported by the terminal. For another example, when the terminal has four antenna combinations, an antenna switching capability of one of the antenna combinations may be reported by the terminal, and antenna switching capabilities of two or three of the antenna combinations may also be reported. That is, the number of part antenna combinations is greater than or equal to 1 and less than all antenna combinations.

In some examples, the antenna switching capability of the antenna combination may be reported to the network device by the terminal through radio resource control (RRC) signaling or other high-level signaling, which is not limited in the example of the disclosure.

In some examples, an index or identifier is allocated to each antenna switching capability, and the index or identifier corresponding to the antenna switching capability supported by the terminal is transmitted to the network device, such that the network device can be caused to determine an antenna switching configuration corresponding to the antenna switching capability according to the index or identifier.

The example of the disclosure provides the method for reporting an antenna switching capability, such that the problem of reporting the antenna switching capability in a case that an uplink transmitting antenna is added for the terminal but the number of downlink data layers is limited is solved. Indication information of the antenna switching capability is reported to the network device, such that the network device can configure appropriate SRS resources for the terminal according to the reported antenna switching capability.

As shown in FIG. 3, FIG. 3 is a flowchart of a method for reporting an antenna switching capability according to an example of the disclosure. As shown in FIG. 3, the method is performed by a terminal and may include, but is not limited to steps S31 and S32.

S31, one or more antenna combinations of the terminal are determined in a case that a number of downlink data layers is less than or equal to a number of transmitting antennas.

For description of S31, reference may be made to description of relevant contents in the other examples, and details are omitted here.

S32, one antenna combination is determined from the plurality of antenna combinations, and an antenna switching capability of the one antenna combination determined is reported.

After one or more antenna combinations of the terminal are determined according to the number of downlink data layers and the number of transmitting antennas. In some examples, in a case that antennas of the terminal are grouped into a plurality of antenna combinations, one antenna combination may be determined from the plurality of antenna combinations, and an antenna switching capability of the determined antenna combination is reported.

In some implementations, an antenna grouping structure adopted by the terminal when receiving a physical downlink shared channel (PDSCH) may be determined based on correlation of a downlink receiving solution of the terminal. One antenna combination is determined from the plurality of antenna combinations according to the antenna grouping structure, that is, the same antenna grouping structure is selected from the antenna combinations.

In some examples, antenna switching capabilities of the determined part antenna combinations may be reported by the terminal simultaneously. In some other examples, the antenna switching capabilities of the determined part antenna combinations may be reported by the terminal separately.

In some examples, the antenna switching capability of the antenna combination may be reported to the network device by the terminal through RRC signaling or other high-level signaling, which is not limited in the example of the disclosure.

In some implementations, when the terminal supports 8Tx, and the maximum number of downlink data layers is four, antenna combinations determined in a case that the number of data layers is limited are two antenna combinations of 4T×4Rx. In order to reduce energy consumption of the terminal, the antenna switching capability of a group including 4T4R may be reported for receiving and transmitting. Alternatively, when the terminal supports 8Tx, and the maximum number of downlink data layers is two, antenna combinations determined in a case that the number of data layers is limited include antenna combinations of 2T×2Rx and 1T×2Rx. In order to reduce energy consumption of the terminal, antenna receiving capabilities of a group including 2T2R may be reported for receiving and transmitting.

The example of the disclosure provides the method for reporting an antenna switching capability, such that the problem of reporting the antenna switching capability in a case that an uplink transmitting antenna is added for the terminal but the number of downlink data layers is limited is solved. Indication information of the antenna switching capability is reported to the network device, such that the network device can configure appropriate SRS resources for the terminal according to the reported antenna switching capability.

As shown in FIG. 4, FIG. 4 is a flowchart of a method for reporting an antenna switching capability according to an example of the disclosure. As shown in FIG. 4, the method is performed by a terminal and may include, but is not limited to steps S41-S431.

S41, at least one of a maximum antenna switching configuration or a maximum number of data layers supported is reported by the terminal to a network device.

In some examples, the supported maximum antenna switching configuration may be reported to the network device by the terminal. For example, in a case that the terminal supports 8Tx, and the number of data layers is limited to eight, the maximum antenna switching configuration supported by the terminal may be 8T8R. For another example, in a case that the terminal supports 8Tx, and the number of data layers is limited to four, the maximum antenna switching configuration supported by the terminal may be 4T4R.

In some examples, the maximum number of data layers may be reported to the network device by the terminal. The maximum number of data layers may be a maximum number of MIMO layers. For example, the maximum number of MIMO layers may be one of two, four, or eight.

In some examples, at least one of the maximum antenna switching configuration or the maximum number of data layers may be reported to the network device by the terminal simultaneously.

In some examples, at least one of the maximum antenna switching configuration or the maximum number of MIMO layers supported by the terminal may be reported to the network device by the terminal through RRC signaling or other high-level signaling, which is not limited in the example of the disclosure.

S42, one or more antenna combinations of the terminal are determined in a case that a number of downlink data layers is less than or equal to a number of transmitting antennas.

It should be noted that the number of downlink data layers of the terminal is less than or equal to the number of transmitting antennas of the terminal, that is, the number of downlink data layers of the terminal is limited. In the example of the disclosure, it may be determined that the terminal determines one or more antenna combinations based on the number of downlink data layers and the number of transmitting antennas in a case that the number of data layers is limited.

S43, antenna switching capabilities of the antenna combinations are reported to the network device.

For description of S43, reference may be made to description of relevant contents in the other examples, and details are omitted here.

The example of the disclosure provides the method for reporting an antenna switching capability, such that the problem of reporting the antenna switching capability in a case that an uplink transmitting antenna is added for the terminal but the number of downlink data layers is limited is solved. Indication information of the antenna switching capability is reported to the network device, such that the network device can configure appropriate SRS resources for the terminal according to the reported antenna switching capability.

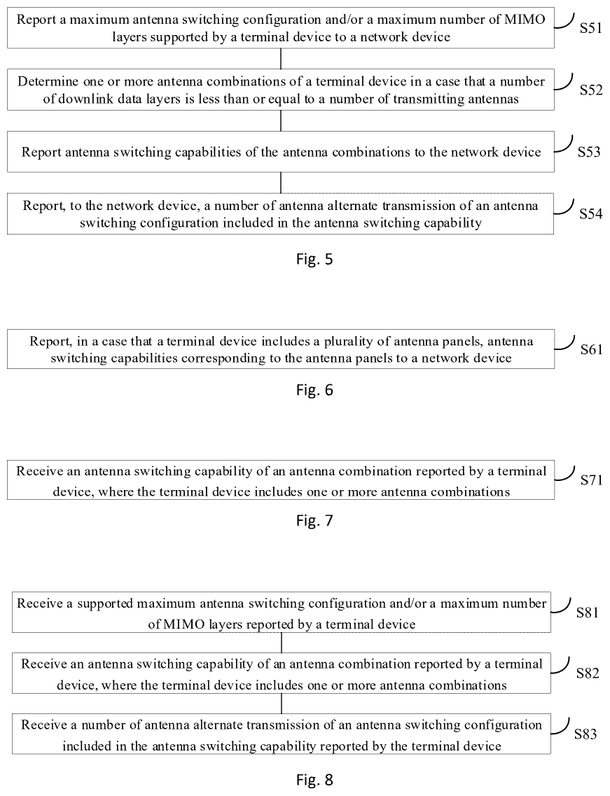

As shown in FIG. 5, FIG. 5 is a flowchart of a method for reporting an antenna switching capability according to an example of the disclosure. As shown in FIG. 5, the method is performed by a terminal and may include, but is not limited to steps S51-S54.

S51, at least one of a maximum antenna switching configuration or a maximum number of data layers supported is reported by the terminal to a network device.

S52, one or more antenna combinations of the terminal are determined in a case that a number of downlink data layers is less than or equal to a number of transmitting antennas.

S53, antenna switching capabilities of the antenna combinations are reported to the network device.

For description of S51-S53, reference may be made to description of relevant contents in the other examples, and details are omitted here.

S54, a number of alternate transmission of an antenna switching configuration among different antenna combinations is reported to the network device, where the antenna switching configuration is included in the antenna switching capability.

Since the terminal needs to perform antenna alternate transmission of sounding reference signals (SRS) in a new radio frequency band among different combinations, to make the network device informed about channel quality of an antenna of the terminal, the number of antenna alternate transmission corresponding to the antenna switching configuration need to be reported. The number of antenna alternate transmission is greater than or equal to one.

In some examples, the number of antenna alternate transmission may be a multiple relation of receiving antennas in the antenna switching configuration. For example, when the combinations is 2T2R, an antenna switching configuration of 1T2R can be reported. When the terminal has eight receiving antennas, the number of antenna alternate transmission among different antenna combinations can be reported as four. For another example, when the combinations is 4T4R, an antenna switching configuration of 2T4R can be reported. When the terminal has eight receiving antennas, the number of antenna alternate transmission among different antenna combinations can be reported as two. It can be understood that the number of antenna alternate transmission is the number of antenna combinations, such that it can be guaranteed that all antennas perform alternate transmission to obtain the channel quality of the antenna of the terminal.

The example of the disclosure provides the method for reporting an antenna switching capability, such that the problem of reporting the antenna switching capability in a case that an uplink transmitting antenna is added for the terminal but the number of downlink data layers is limited is solved. Indication information of the antenna switching capability is reported to the network device, such that the network device can configure appropriate SRS resources for the terminal according to the reported antenna switching capability.

As shown in FIG. 6, FIG. 6 is a flowchart of a method for reporting an antenna switching capability according to an example of the disclosure. As shown in FIG. 6, the method is performed by a terminal and may include, but is not limited to step S61.

S61, in a case that the terminal includes a plurality of antenna panels, antenna switching capabilities corresponding to the antenna panels are reported to a network device.

In some examples, the terminal is a terminal including a plurality of antenna panels. Different panels may correspond to different antenna combinations, that is, each panel may correspond to an antenna combination. For example, the terminal includes two antenna panels, and four downlink data layers reported to the network device are provided. Since the maximum number of layers supported by different antenna panels is different, the maximum number of layers supported by one antenna panel is one, and the maximum number of layers supported by the other antenna panel is four, the antenna switching capabilities corresponding to the two panels in the example of the disclosure may be 1T4R and 4T4R respectively. For another example, the terminal includes three antenna panels, and four downlink data layers reported to the network device are provided. Since the maximum number of layers supported by different antenna panels is different, the maximum number of layers supported by antenna panel A is one, the maximum number of layers supported by antenna panel B is one, and the maximum number of layers supported by antenna panel C is four, the antenna switching capabilities corresponding to the two panels in the example of the disclosure may be 1T4R and 4T4R respectively.

In some implementations, antenna switching capabilities of all the antenna panels are reported to the network device simultaneously. In some other implementations, antenna switching capabilities of all the antenna panels are reported to the network device separately. In still other implementations, antenna switching capabilities of some of all the antenna panels are reported to the network device. The antenna switching capability of each antenna panel may be the same or not.

The method for reporting an antenna switching capability provided in the example of the disclosure further includes before the antenna switching capability corresponding to the antenna panel is reported to the network device, at least one of the maximum supported antenna switching configuration or the maximum number of data layers may be reported to the network device by the terminal. For example, in a case that the terminal supports 8Tx, and the number of data layers is limited to four, the maximum antenna switching configuration supported by the terminal may be 4T4R. For another example, in a case that the terminal supports 8Tx, and the number of data layers is limited to two, the maximum antenna switching configuration supported by the terminal may be 2T4R.

In some examples, the maximum number of MIMO layers may be one of two, four, or eight.

In some examples, at least one of the maximum antenna switching configuration or the maximum number of data layers may be reported simultaneously or separately. In some examples, at least one of the maximum antenna switching configuration or the maximum number of data layers supported by the terminal may be reported to the network device by the terminal through RRC signaling or other high-level signaling, which is not limited in the example of the disclosure.

The method for reporting an antenna switching capability provided in the example of the disclosure further includes a number of antenna alternate transmission of an antenna switching configuration included in the antenna switching capability is reported to the network device. Since the terminal needs to perform antenna alternate transmission of sounding reference signals (SRS) among different antenna combinations in a new radio frequency band, to make the network device informed about channel quality of an antenna of the terminal, the number of antenna alternate transmission corresponding to the antenna switching configuration need to be reported. The number of antenna alternate transmission is greater than or equal to one. In some examples, the number of antenna alternate transmission may be a multiple relation of receiving antennas in the antenna switching configuration. For example, the antenna alternate transmission of the antenna switching configuration of 1T2R may be performed twice, and the antenna transmission of the antenna switching configuration of 2T4R may be performed eight times.

The example of the disclosure provides the method for reporting an antenna switching capability, such that the problem of reporting the antenna switching capability in a case that an uplink transmitting antenna is added for the terminal but the number of downlink data layers is limited is solved. Indication information of the antenna switching capability is reported to the network device, such that the network device can configure appropriate SRS resources for the terminal according to the reported antenna switching capability.

As shown in FIG. 7, FIG. 7 is a flowchart of a method for reporting an antenna switching capability according to an example of the disclosure. As shown in FIG. 7, the method is performed by a network device and may include, but is not limited to step S71.

S71, an antenna switching capability of an antenna combination reported by a terminal is received, where the terminal includes one or more antenna combinations.

In the example of the disclosure, the number of downlink data layers of the terminal is less than or equal to the number of transmitting antennas of the terminal, that is, the number of downlink data layers of the terminal, that is, the number of multiple input multiple output (MIMO) layers is limited. For example, when the terminal is configured with eight transmitting antennas (Transport, Tx), and four downlink data layers are provided, the terminal is in a situation of a limited number of data layers. For another example, when the terminal is configured with 8Tx, and the maximum number of downlink data layers is eight, the terminal is still in a situation of a limited number of data layers.

In the example of the disclosure, it may be determined that the terminal determines one or more antenna combinations based on the number of downlink data layers and the number of transmitting antennas in a case that the number of data layers is limited. For example, when the terminal supports 8Tx, and the number of downlink data layers is limited to four, two antenna transceiving combinations of 4T×4Rx may be generated. For another example, when the terminal supports 4Tx, and the number of downlink data layers is limited to two, two antenna transceiving combinations of 2T×2Rx may be generated. For another example, when the terminal supports 8Tx, and the number of downlink data layers is limited to two, four antenna transceiving combinations of 2T×2Rx may be generated.

Different antenna combinations correspond to different antenna switching capabilities. Accordingly, SRS resources configured by the network device for the terminals with different antenna switching capabilities are also different, such the network device needs to configure SRS resources matching the antenna switching capabilities within a capability range based on the capabilities reported by the terminal. In the example, the antenna switching capabilities of the antenna combinations may be transmitted from the terminal to the network device, such that the network device may be informed about a plurality of transceiving capabilities that the terminal can support, and one or more corresponding SRS resources may be further configured for the terminal according to the plurality of transceiving capabilities that the terminal can support. The SRS resource may be configured to obtain channel state information (CSI), and further to obtain uplink channel quality.

Continuing to take the situation that the terminal supports 8Tx and the number of downlink data layers is limited to four as an example, 8Tx of the terminal may be divided into two antenna combinations of 4T×4Rx. Antenna switching capabilities corresponding to the two antenna combinations of 4T×4Rx may both be 4T4R, or may both be 2T4R, or may be 1T4R and 2T4R respectively.

In some examples, grouping may be performed based on Tx or Rx, an antenna combination of the terminal may be nTmR, where n and m are positive integers greater than or equal to 1 and less than or equal to the number of transmitting antennas. In some examples, the terminal is a terminal including a plurality of antenna panels. Different panels may correspond to different antenna combinations.

In some examples, an antenna switching capability of each antenna combination may be reported by the terminal simultaneously, and accordingly, the antenna switching capability of each antenna combination may be received by the network device simultaneously. In some other examples, the antenna switching capabilities of each the antenna combinations may be reported by the terminal separately, and accordingly, the antenna switching capabilities of each the antenna combinations may be received by the network device separately. In still other examples, switching capabilities of part antenna combinations of all the antenna combinations may be reported by the terminal, and accordingly, the antenna switching capabilities of part antenna combinations may be received by the network device.

In some examples, the antenna switching capability of the antenna combination may be reported to the network device by the terminal through RRC signaling or other high-level signaling, which is not limited in the example of the disclosure.

In some examples, an index or identifier is allocated to each antenna switching capability, the index or identifier corresponding to the antenna switching capability supported by the terminal is transmitted to the network device, and accordingly, the network device can be caused to determine an antenna switching configuration corresponding to the antenna switching capability according to the index or identifier.

The example of the disclosure provides the method for reporting an antenna switching capability, such that the problem of reporting the antenna switching capability in a case that an uplink transmitting antenna is added for the terminal but the number of downlink data layers is limited is solved. Indication information of the antenna switching capability is reported to the network device, such that the network device can configure appropriate SRS resources for the terminal according to the reported antenna switching capability.

As shown in FIG. 8, FIG. 8 is a flowchart of a method for reporting an antenna switching capability according to an example of the disclosure. As shown in FIG. 8, the method is performed by a network device and may include, but is not limited to steps S81-S83.

S81, at least one of a supported maximum antenna switching configuration or a maximum number of MIMO layers reported by a terminal is received.

For example, in a case that the terminal supports 8Tx, and the number of data layers is limited to eight, the maximum antenna switching configuration supported by the terminal that the network device can receive may be 8T8R. For example, in a case that the terminal supports 8Tx, and the number of data layers is limited to four, the maximum antenna switching configuration supported by the terminal that the network device can receive may be 4T4R.

In some examples, the maximum number of data layers may be reported to the network device by the terminal. For example, the number of data layers may be the maximum number of MIMO layers and may be one of two, four, or eight.

In some examples, at least one of the maximum antenna switching configuration or the maximum number of data layers reported by the terminal may be received by the network device simultaneously.

In some examples, at least one of the maximum antenna switching configuration or the maximum number of MIMO layers supported by the terminal may be reported to the network device by the terminal through RRC signaling or other high-level signaling, which is not limited in the example of the disclosure.

S82, an antenna switching capability of an antenna combination reported by the terminal is received, where the terminal includes one or more antenna combinations.

The antenna combinations may be obtained by grouping according to Tx or Rx of the terminal. In a case that the terminal includes antenna panels, each antenna panel corresponds to one antenna combination. That is to say, the antenna switching capability of the antenna panel reported by the terminal is received by the network device. In some implementations, antenna switching capabilities of all the antenna panels may be received by the network device simultaneously. In some other implementations, antenna switching capabilities of all the antenna panels may be received by the network device separately. In still other implementations, antenna switching capabilities of some of all the antenna panels may be received by the network device. The antenna switching capability of each antenna panel may be the same or not.

For description of S82, reference may be made to description of relevant contents in the other examples, and details are omitted here.

S83, a number of antenna alternate transmission of an antenna switching configuration included in the antenna switching capability reported by the terminal is received.

The number of antenna alternate transmission of an antenna switching configuration included in the antenna switching capability may be received by the network device. Since the terminal needs to perform antenna alternate transmission of sounding reference signals (SRS) among different antenna combinations in a new radio frequency band, to make the network device informed about channel quality of an antenna of the terminal, the number of antenna alternate transmission corresponding to the antenna switching configuration need to be reported. The number of antenna alternate transmission is greater than or equal to one. In some examples, the number of antenna alternate transmission may be a multiple relation of receiving antennas in the antenna switching configuration. For example, the number of the antenna alternate transmission of the antenna switching configuration of 1T2R may be performed twice, and the number of the antenna alternate transmission of the antenna switching configuration of 2T4R may be performed eight times.

The example of the disclosure provides the method for reporting an antenna switching capability, such that the problem of reporting the antenna switching capability in a case that an uplink transmitting antenna is added for the terminal but the number of downlink data layers is limited is solved. Indication information of the antenna switching capability is reported to the network device, such that the network device can configure appropriate SRS resources for the terminal according to the reported antenna switching capability.

In the examples provided in the disclosure, the method provided by the examples of the disclosure is introduced from the perspectives of a terminal and a network device separately. In order to implement functions in the method provided in the examples of the disclosure, the terminal and the network device may include a hardware structure and a software module. The functions are implemented in a form of a hardware structure, a software module, or a hardware structure and a software module. Any one of the functions may be executed by a hardware structure, a software module, or a hardware structure and a software module.

The examples of the disclosure provide a communication apparatus. The communication apparatus has some or all of functions of the terminal in the methods. For example, the communication apparatus may have some or all of the functions in the examples of the disclosure, or may have the functions of implementing any one of the examples of the disclosure alone. The functions may be implemented through hardware, or by executing corresponding software by hardware. The hardware or software includes one or more units or modules corresponding to the functions.

In an implementation, a structure of the communication apparatus may include a transceiving module (I/O device) and a processing module (processor). The processing module is configured to support the communication apparatus to execute corresponding functions in the methods. The transceiving module is configured to support communication between the communication device and other devices. The communication device may further include a storage module (memory). The storage module is configured to be coupled with the transceiving module and the processing module and store computer programs and data necessary for the communication apparatus.

As an instance, the processing module may be a processor, the transceiving module may be a transceiver or a communication interface, and the storage module may be a memory.

The examples of the disclosure provide another communication apparatus. The communication apparatus has some or all of functions of the network device in the methods. For example, the communication apparatus may have some or all of the functions in the examples of the disclosure, or may have the functions of implementing any one of the examples of the disclosure alone. The functions may be implemented through hardware, or by executing corresponding software by hardware. The hardware or software includes one or more units or modules corresponding to the functions.

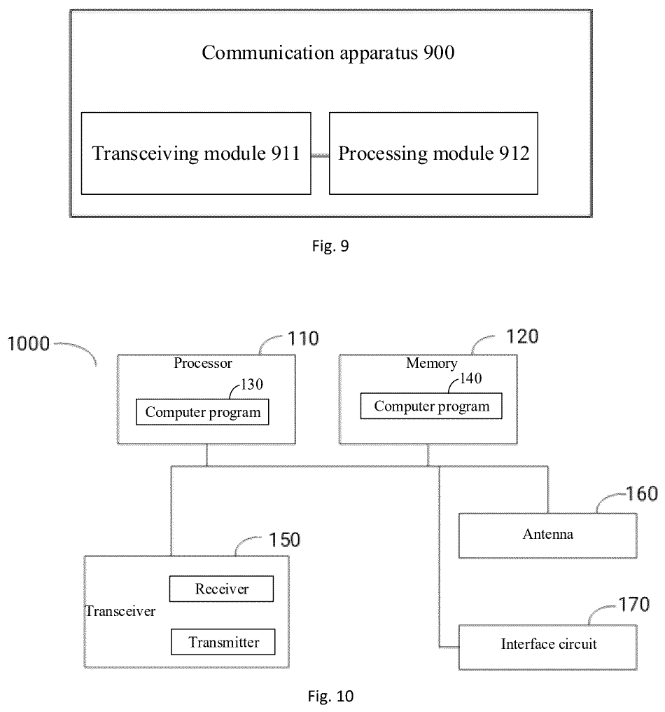

With reference to FIG. 9, a schematic structural diagram of a communication apparatus 900 according to an example of the disclosure is provided. The communication apparatus 900 shown in FIG. 9 may include a transceiving module 911 and a processing module 912. The transceiving module 911 may include at least one of a transmitting module or a receiving module (not shown). The transmitting module is configured to implement a transmitting function. The receiving module is configured to implement a receiving function. The transceiving module 911 may implement at least one of the transmitting function or the receiving function.

The communication apparatus 900 may be a terminal (such as the terminal in the method examples), an apparatus in the terminal, or an apparatus that can be used in conjunction with the terminal. Alternatively, the communication apparatus 900 may be a network device, an apparatus in a network device, or an apparatus that can be used in conjunction with the network device.

The communication apparatus 900 is a terminal and includes a processing module 912 configured to determine one or more antenna combinations of a terminal in a case that a number of downlink data layers is less than or equal to a number of transmitting antennas; and a transceiving module 911 configured to report antenna switching capabilities of the antenna combinations to a network device.

In some examples, the transceiving module 911 is further configured to report antenna switching capabilities of all the antenna combinations to the network device simultaneously, or report antenna switching capabilities of all the antenna combinations to the network device separately.

In some examples, the transceiving module 911 is further configured to report antenna switching capabilities of partial antenna combinations to the network device.

In some examples, the transceiving module 911 is further configured to determine one antenna combination from the one or more antenna combinations, and report an antenna switching capability of the one antenna combination determined.

In some examples, the terminal supports eight transmitting antennas Tx, and the processing module 912 is further configured to obtain the one or more antenna combinations by grouping transmitting antennas Tx or receiving antennas Rx of the terminal.

In some examples, before the antenna switching capability of the antenna combination is reported to the network device, the transceiving module 911 is further configured to report at least one of a maximum antenna switching configuration or a maximum number of data layers supported by the terminal to the network device.

In some examples, the maximum antenna switching configuration is 8T8R, and the maximum number of data layers is 4.

In some examples, the maximum antenna switching configuration is 4T4R.

In some examples, the transceiving module 911 is further configured to report a number of antenna alternate transmission of the antenna switching configuration included in the antenna switching capability to the network device when the antenna switching capability of the antenna combination is reported to the network device.

In some examples, the terminal includes a plurality of antenna panels, and each antenna panel includes one antenna combination.

In some examples, the transceiving module 911 is further configured to report antenna switching capabilities of all the antenna panels to the network device simultaneously, or report antenna switching capabilities of all the antenna panels to the network device separately. The switching capability of each antenna combination may be the same or different.

In some examples, the transceiving module 911 is further configured to report antenna switching capabilities of part antenna panels of all the antenna panels to the network device.

In some examples the communication apparatus 900 is a network device and includes a transceiving module 911 configured to receive an antenna switching capability of an antenna combination reported by a terminal, where the terminal includes one or more antenna combinations.

In some examples, the transceiving module 911 is further configured to receive antenna switching capabilities of all the antenna combinations reported simultaneously by the terminal, or receive antenna switching capabilities of all the antenna combinations reported by the terminal separately.

In some examples, the transceiving module 911 is further configured to receive antenna switching capabilities of part antenna combinations reported by the terminal.

In some examples, the antenna combination is obtained by grouping Tx or Rx of the terminal.

In some examples, the transceiving module 911 is further configured to receive at least one of a supported maximum antenna switching configuration or a maximum number of data layers reported by the terminal before the antenna switching capability of the antenna combination reported by the terminal is received.

In some examples, the maximum antenna switching configuration is 8T8R, and the maximum number of data layers is 4.

In some examples, the maximum antenna switching configuration is 4T4R.

In some examples, the transceiving module 911 is further configured to receive the number of antenna alternate transmission of the antenna switching configuration included in the antenna switching capability reported by the terminal when the antenna switching capability of the antenna combination reported by the terminal is received.

In some examples, the antenna combination is an antenna combination reported by an antenna panel included in the terminal.

In some examples, the transceiving module 911 is further configured to receive the antenna switching capabilities of all antenna panels reported simultaneously by the terminal, or receive the antenna switching capability of each antenna panel reported by the terminal separately.

In some examples, the transceiving module 911 is further configured to receive antenna switching capabilities of part antenna panels of all antenna panels reported by the terminal.

The example of the disclosure provides the method for reporting an antenna switching capability, such that the problem of reporting the antenna switching capability in a case that an uplink transmitting antenna is added for the terminal but the number of downlink data layers is limited is solved. Indication information of the antenna switching capability is reported to the network device, such that the network device can configure appropriate SRS resources for the terminal according to the reported antenna switching capability.

With reference to FIG. 10, FIG. 10 is a schematic structural diagram of another communication apparatus 1000 according to an example of the disclosure. The communication apparatus 1000 may be a terminal, may be a network device, may be a chip, a chip system, or a processor that supports a terminal to implement the methods, and may also be a chip, a chip system, or a processor that supports a network device to implement the methods. The apparatus may be configured to implement the methods described in the method examples, and reference may be made to description in the method examples for details. The communication apparatus 1000 of FIG. 10 includes a processor 110, a memory 120, a transceiver 150, an antenna 160, and an interface circuit 170.

The communication apparatus 1000 may include one or more processors 110. The processor 110 may be a general purpose processor or a special purpose processor, etc., such as a baseband processor or a central processor. The baseband processor may be configured to process a communication protocol and communication data. The central processor may be configured to control a communication apparatus (for example, a base station, a baseband chip, a terminal, a terminal chip, a DU or a CU), execute a computer program 130, and process data of the computer program.

In some examples, the communication apparatus 1000 may further include one or more memories 120 that may store a computer program 140. The processor 110 executes the computer program 140 to cause the communication apparatus 1000 to execute any of the method described in the method examples. In some examples, the memory 120 may also store data. The communication apparatus 1000 and the memory 120 may be set separately or may be integrated together.

The transceiver 150 may be referred to as a transceiver unit, a transceiver machine, or a transceiver circuit, input/output (I/O) device etc., and is configured to implement a transmit-receive function. The transceiver 150 may include a receiver and a transmitter. The receiver may be referred to as a receiver machine or a receiving circuit, etc., for implementing a reception function. The transmitter may be referred to as a transmitter machine or a transmitting circuit, etc., for implementing a transmission function.

In some examples, the communication apparatus 1000 may further include one or more interface circuits 170. The interface circuit 170 is configured to receive a code instruction and transmit the code instruction to the processor 110. The processor 110 carries out the code instruction to cause the communication apparatus 1000 to execute the methods described in the method examples.

In an implementation, the processor 110 may include a transceiver for implementing a reception function and a transmission function. For example, the transceiver may be a transceiver circuit, or an interface, or an interface circuit. The transceiver circuit, interface, or interface circuit for implementing the reception function and the transmission function may be separated or integrated. The transceiver circuit, interface or interface circuit may be configured to read and write a code/data, and alternatively, the transceiver circuit, interface or interface circuit may be configured to transmit or transfer a signal.

In one implementation, the processor 110 may store a computer program 130. The computer program 130 runs on the processor 110 and causes the communication device 1000 to execute the methods described in the method examples. The computer program 130 may be embedded in the processor 110. In this case, the processor 110 may be implemented by hardware.

In an implementation, the communication apparatus 1000 may include a circuit that may implement the functions of transmission, reception or communication in the method examples. The processor and transceiver described in the disclosure may be implemented on an integrated circuit (ICs), an analog IC, a radio frequency integrated circuit (RFIC), a mixed-signal IC, an application specific integrated circuit (ASIC), a printed circuit board (PCB), an electronic device, etc. The processor and transceiver may also be fabricated using various IC process technologies, such as a complementary metal oxide semiconductor (CMOS), an n-metal-oxide-semiconductor (NMOS), a positive channel metal oxide semiconductor (PMOS), a bipolarjunction transistor (BJT), a bipolar CMOS (BiCMOS), silicon germanium (SiGe), gallium arsenide (GaAs), etc.

The communication apparatus 1000 described may be a transmitting device or a receiving device (such as the receiving device in the method examples), but the scope of the communication apparatus described in the disclosure is not limited to this, and a structure of the communication apparatus 1000 may not be limited by FIG. 10. The communication apparatus may be a stand-alone device or may be part of a larger device. For example, the communication apparatus may be: (1) an independent integrated circuit (IC), a chip, a chip system or a subsystem; (2) a set of one or more ICs, In some examples including a memory component for storing data and a computer program; (3) an ASIC, such as a modem; (4) a module that can be embedded in other devices; (5) a receiver machine, a terminal, an intelligent terminal, a cellular phone, a radio device, a handset, a mobile unit, a vehicle-mounted device, a network device, a cloud device, an artificial intelligence device, etc.; and (6) a different apparatus, etc.

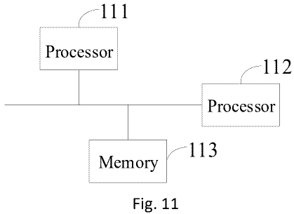

Reference may be made to a schematic structural diagram of a chip shown in FIG. 11 for the case that the communication apparatus may be a chip or a chip system. The chip shown in FIG. 11 includes a processor 111, an interface 112, and a memory 113. One or more processors 111 may be provided. A plurality of interfaces 112 may be provided. The memory 113 is configured to store a computer program and data.

Those skilled in the art will further appreciate that the various illustrative logical blocks and steps set forth in the examples of the disclosure may be implemented by electronic hardware, computer software, or combinations of both. Whether such functions are implemented by hardware or software depends on a particular application and overall system design requirements. Those skilled in the art may use various methods to implement the functions for each particular application, but such implementation should not be understood as beyond the scope of protection of the examples of the disclosure.

The examples of the disclosure further provide a system for reporting an antenna switching capability. The system includes the communication apparatus serving as a terminal (such as the terminal in the method examples) and the communication apparatus serving as a network device in the example of FIG. 9. Alternatively, the system includes the communication apparatus serving as a terminal (such as the terminal in the device method examples) and the communication apparatus serving as a network device in the example of FIG. 10.

The disclosure further provides a non-transitory computer-readable storage medium. The non-transitory computer-readable storage medium stores an instruction. The instruction implements the functions of any one of the method examples when executed by a computer.

The disclosure further provides a computer program product. The computer program product implements the functions of the method examples when executed by a computer.

The examples described herein can be implemented in whole or in part by software, hardware, firmware, or their any combinations. When implemented by software, the examples can be implemented in whole or in part as a computer program product. The computer program product includes one or more computer programs. When loaded and executed on a computer, the computer program generates in whole or in part the flows or functions described in accordance with the examples of the disclosure. The computer may be a general-purpose computer, a special-purpose computer, a computer network, or another programmable device. The computer program may be stored in a computer-readable storage medium or transmitted from one computer-readable storage medium to another computer-readable storage medium. For example, the computer program can be transmitted from one website, computer, server, or data center to another website, computer, server, or data center by a wire (for example, coaxial cable, optical fiber, digital subscriber line (DSL)) or radio (for example, infrared, radio, microwave, etc.). The computer-readable storage medium may be any available medium that can be accessed by a computer or a data storage device including one or more available media integrated as a server, data center, etc. The available medium may be a magnetic medium (for example, floppy disk, hard disk, magnetic tape), an optical medium (for example, digital video disk (DVD)), or a semiconductor medium (for example, solid state disk (SSD)), etc.

Those skilled in the art may understand that the first, second and other numerical numbers referred to in the disclosure are merely for distinction for convenience of description, and are not intended to limit the scope of the examples of the disclosure, and also represent the sequence.

At least one in the disclosure may also be described as one or more, and the plurality may be two, three, four, or more, which are not limited in the disclosure. In the examples of the disclosure, for a type of technical features, technical features in this type of the technical features are distinguished by “first”, “second”, “third”, “A”, “B”, “C” and “D”, and the technical features described by the “first”, “second”, “third”, “A”, “B”, “C” and “D” have no sequence or order of magnitude.

Corresponding relations shown in tables of the disclosure may be configured or predefined. Values of information in each table are instances, may be configured differently, which are not limited in the disclosure. When a corresponding relation between the information and each parameter is configured, it is not necessarily required to configure all the corresponding relations indicated in each table. For example, in the tables of the disclosure, the corresponding relations shown in some rows may not be configured. For another example, appropriate deformation adjustments, such as splitting, merging, etc., can be made based on the table. Names of the parameters shown in the titles of the tables may also be other names that can be understood by the communication apparatus, and values or expression modes of the parameters may also be other values or expression modes that can be understood by the communication apparatus. When the tables are implemented, other data structures may also be used, such as an array, a queue, a container, a stack, a linear table, a pointer, a linked list, a tree, a graph, a structure, a class, a heap, or a hash table.

Predefinition in the disclosure may be understood as definition, predefinition, storage, pre-storage, pre-negotiation, pre-configuration, curing, or pre-firing.

Those of ordinary skill in the art may appreciate that the units and algorithm steps of the instances described in conjunction with the examples disclosed here may be implemented in electronic hardware, or a combination of computer software and electronic hardware. Whether these functions are performed with hardware or software depends on the specific application and design constraints of the technical solution. Those skilled in the art can use different methods to implement the described functions for each particular application, but such implementation should not be deemed as beyond the scope of the disclosure.

Those skilled in the art will clearly appreciate that, for convenience and conciseness of description, reference can be made to corresponding processes in the method examples for specific working processes of the systems, devices and units, which are not repeated here.

What are described herein are merely particular embodiments of the disclosure, and are not intended to limit the scope of protection of the disclosure, and any changes or substitutions that can readily occur to those skilled in the art within the scope of technology disclosed in the disclosure should fall within the scope of protection of the disclosure. Thus, the scope of protection of the disclosure shall be subject to the scope of protection of the claims.

1. A method for reporting an antenna switching capability, performed by a terminal, comprising:
determining one or more antenna combinations of the terminal in a case that a number of downlink data layers is less than or equal to a number of transmitting antennas; and
reporting antenna switching capabilities of the one or more antenna combinations to a network device.

2. The method according to claim 1, wherein reporting the antenna switching capabilities of the one or more antenna combinations to the network device comprises at least one of:
reporting the antenna switching capabilities of all the one or more antenna combinations to the network device simultaneously;
reporting the antenna switching capabilities of all the one or more antenna combinations to the network device separately; or
reporting the antenna switching capabilities of portion of the one or more antenna combinations to the network device.

3. The method according to claim 2, wherein reporting the antenna switching capabilities of the portion of the one or more antenna combinations to the network device comprises:
determining one antenna combination from the one or more of antenna combinations, and reporting an antenna switching capability of the one antenna combination.

4. The method according to claim 1, wherein the terminal supports eight transmitting antennas Tx, and determining the one or more antenna combinations of the terminal comprises:
obtaining the one or more antenna combinations by grouping the transmitting antennas Tx or receiving antennas Rx of the terminal.

5. The method according to claim 1, further comprises:
reporting at least one of a maximum antenna switching configuration or a maximum number of data layers supported by the terminal to the network device.

6. The method according to claim 5, wherein
the maximum antenna switching configuration is 8T8R, and the maximum number of data layers is 4; or
the maximum antenna switching configuration is 4T4R.

7. (canceled)

8. The method according to claim 1, wherein in response to determining that the antenna switching capabilities of the one or more antenna combinations are reported to the network device, the method further comprises:
reporting, to the network device, a number of alternate transmission of an antenna switching configuration among different antenna combinations, wherein the antenna switching configuration is comprised in the antenna switching capabilities.

9. The method according to claim 1, wherein the terminal comprises a plurality of antenna panels, and each antenna panel comprises one antenna combination.

10. The method according to claim 9, wherein reporting the antenna switching capabilities of the one or more antenna combinations to the network device comprises at least one of:
reporting the antenna switching capabilities of all the plurality of antenna panels to the network device simultaneously;
reporting the antenna switching capabilities of all the plurality of antenna panels to the network device separately; or
reporting the antenna switching capabilities of a portion of the plurality of antenna panels to the network device, and
wherein the antenna switching capability of each of the plurality of antenna combinations are one of a same capability, a different capability or a combination of the same capability or the different capability.

11. A method for reporting an antenna switching capability, performed by a network device, comprising:
receiving an antenna switching capability of an antenna combination reported by a terminal, wherein the terminal comprises one or more antenna combinations.

12. The method according to claim 11, wherein receiving the antenna switching capability of the antenna combination reported by the terminal comprises at least one of:
receiving the antenna switching capability of all of the one or more antenna combinations reported simultaneously by the terminal;
receiving the antenna switching capability of all of the one or more antenna combinations reported by the terminal separately; or
receiving the antenna switching capability of a portion of the one or more antenna combinations reported by the terminal.

13. (canceled)

14. The method according to claim 11, further comprises:
receiving at least one of a supported maximum antenna switching configuration or a supported maximum number of data layers reported by the terminal.

15.-16. (canceled)

17. The method according to claim 11, wherein in response to determining that the antenna switching capability of the antenna combination reported by the terminal is received, the method further comprises:
receiving a number of alternate transmission of an antenna switching configuration among different antenna combinations reported by the terminal, wherein the antenna switching configuration is comprised in the antenna switching capability.

18. The method according to claim 11, wherein the antenna combination is reported by an antenna panel comprised in the terminal.

19. The method according to claim 18, wherein receiving the antenna switching capability of the antenna combination reported by the terminal comprises at least one of:
receiving the antenna switching capability of all antenna panels reported simultaneously by the terminal;
receiving the antenna switching capability of all antenna panels reported by the terminal separately; or
receiving the antenna switching capability of a portion of antenna panels reported by the terminal.

20.-21. (canceled)

22. A communication apparatus, comprising one or more processors and a memory, wherein the memory stores a computer program, and the one or more processors are collectively configured to execute the computer program stored in the memory, so as to cause the communication apparatus to:
determine one or more antenna combinations of the terminal in a case that a number of downlink data layers is less than or equal to a number of transmitting antennas; and
report antenna switching capabilities of the one or more antenna combinations to a network device.

23. A communication apparatus, comprising one or more processors and a memory, wherein the memory stores a computer program, and the one or more processors are collectively configured to execute the computer program stored in the memory, so as to cause the communication apparatus to execute the method according to claim 11.

24. A communication apparatus, comprising one or more processors and an interface circuit, wherein
the interface circuit is configured to receive a code instruction and transmit the code instruction to the one or more processors; and
the one or more processors are configured to carry out the code instruction, so as to execute the method according to claim 1.

25. A communication apparatus, comprising one or more processors and an interface circuit, wherein
the interface circuit is configured to receive a code instruction and transmit the code instruction to the one or more processors, and
the one or more processors are configured to carry out the code instruction, so as to execute the method according to claim 11.

26. A non-transitory computer-readable storage medium, configured to store an instruction, wherein when the instruction is executed by a processor, the instruction causes the processor to implement the method according to claim 1.

27. (canceled)
